(19) United States
(12) Patent Application Publication
(10) Pub. No.: US 2022/0285830 A1
(43) Pub. Date: Sep. 8, 2022

(54) HYBRID LOW-FREQUENCY AND HIGH-FREQUENCY RADAR SYSTEM

(71) Applicant: GM Global Technology Operations LLC, Detroit, MI (US)

(72) Inventors: Oded Bialer, Petah Tivak (IL); Amnon Jonas, Herzliya (IL)

(21) Appl. No.: 17/189,752

(22) Filed: Mar. 2, 2021

(51) Int. Cl. H01Q 1/32; G01S 13/931; G01S 13/87; H01Q 3/34; H01Q 21/00; G01S 7/03

(52) U.S. Cl. CPC H01Q 1/3233; G01S 13/931; G01S 13/874; H01Q 3/34; H01Q 21/0075; G01S 7/03

(57) ABSTRACT

A hybrid radar system includes one or more low-frequency antennas configured to receive low-frequency reflected energy resulting from reflection of low-frequency transmissions, and one or more high-frequency antennas configured to receive high-frequency reflected energy resulting from reflection of high-frequency transmission. A frequency of the high-frequency transmissions is at least 1.5 times a frequency of the low-frequency transmissions. A processor obtains and processes one or more low-frequency digital signals resulting from the low-frequency reflected energy received at each of the one or more low-frequency antennas and one or more high-frequency digital signals resulting from the high-frequency reflected energy received at each of the one or more high-frequency antennas. The processor controls an operation of the vehicle based on information obtained by processing the low-frequency reflected energy and the high-frequency reflected energy.

### INTRODUCTION

The subject disclosure relates to a hybrid low-frequency and high-frequency radar system.

Vehicles (e.g., automobiles, trucks, construction equipment, farm equipment, automated factory equipment) increasingly include sensors to obtain information about the vehicle and its environment. Exemplary sensors that obtain information about the environment around the vehicle include cameras, light detection and ranging (lidar) systems, and radio detection and ranging (radar) systems. A radar system generally transmits radio frequency (RF) signals and obtains reflections based on one or more objects reflecting the transmitted RF signals. By processing the reflections, range, Doppler (i.e., range rate), and direction of arrival (e.g., azimuth angle, elevation angle) of reflections from each of the objects can be obtained. The frequency of the transmitted RF signals affects the resolution. Accordingly, it is desirable to provide a hybrid low-frequency and high-frequency radar system.

### SUMMARY

In one exemplary embodiment, a hybrid radar system includes one or more low-frequency antennas to receive low-frequency reflected energy resulting from reflection of low-frequency transmissions, and one or more high-frequency antennas to receive high-frequency reflected energy resulting from reflection of high-frequency transmissions. A frequency of the high-frequency transmissions is at least 1.5 times a frequency of the low-frequency transmissions. A processor obtains and processes one or more low-frequency digital signals resulting from the low-frequency reflected energy received at each of the one or more low-frequency antennas and one or more high-frequency digital signals resulting from the high-frequency reflected energy received at each of the one or more high-frequency antennas and to control an operation of a vehicle based on information obtained by processing the low-frequency reflected energy and the high-frequency reflected energy.

In addition to one or more of the features described herein, the hybrid radar system also includes one or more first channels corresponding with the one or more low-frequency antennas to output the one or more low-frequency digital signals and one or more second channels corresponding with the one or more high-frequency antennas to output the one or more high-frequency digital signals.

In addition to one or more of the features described herein, the hybrid radar system also includes one or more channels. Each of the one or more channels corresponds, in turn, with one of the one or more low-frequency antennas to output one of the one or more low-frequency digital signals and with one of the one or more high-frequency antennas to output one of the one or more high-frequency digital signals. The hybrid radar system additionally includes one or more switches. Each of the one or more switches couples one of the one or more low-frequency antennas or one of the one or more high-frequency antennas to one of the one or more channels in turn.

In addition to one or more of the features described herein, the processor performs a fast Fourier transform (FFT) on the one or more low-frequency digital signals over a set of range values to obtain one or more low-frequency range FFT results and to perform an FFT on the one or more high-frequency digital signals to obtain one or more high-frequency range FFT results.

In addition to one or more of the features described herein, the processor performs a second FFT on a combination of the one or more low-frequency range FFT results over a set of Doppler values to obtain a low-frequency Doppler FFT result.

In addition to one or more of the features described herein, based on the low-frequency Doppler FFT result, the processor obtains a low-frequency beamforming result that indicates an energy level at each of the set of range values, each of the set of Doppler values, and each of a set of angles at which an object may be positioned and to detect one or more objects based on the indication of energy level, each of the one or more objects being associated with one of the set of range values, one of the set of Doppler values, and one of the set of angles.

In addition to one or more of the features described herein, the processor identifies one or more regions of interest (ROI) corresponding with each of the one or more objects, each ROI including the one of the set of range values, the one of the set of Doppler values, and the one of the set of angles associated with the object and the ROI corresponding with ROI range values, ROI Doppler values and ROI angles.

In addition to one or more of the features described herein, the processor performs a second FFT or a discrete Fourier transform (DFT) on a combination of portions of the one or more high-frequency range FFT results that correspond with the ROI range values over a set of Doppler values that correspond with the ROI Doppler values to obtain a high-frequency Doppler Fourier transform result.

In addition to one or more of the features described herein, based on the high-frequency Doppler Fourier transform result, the processor obtains a high-frequency beamforming result that indicates an energy level at each of the ROI range values, each of the ROI Doppler values, and each of the ROI angles and to detect one or more objects based on the indication of energy level.

In addition to one or more of the features described herein, the processor retains only ones of the one or more objects detected using the high-frequency beamforming result that correspond with one of the one or more objects detected using the low-frequency beamforming result.

In another exemplary embodiment, a method of assembling a hybrid radar system includes arranging one or more low-frequency antennas to receive low-frequency reflected energy resulting from reflection of low-frequency transmissions, and arranging one or more high-frequency antennas to receive high-frequency reflected energy resulting from reflection of high-frequency transmission. A frequency of the high-frequency transmissions is at least 1.5 times a frequency of the low-frequency transmissions. The method also includes configuring a processor to obtain and process one or more low-frequency digital signals resulting from the low-frequency reflected energy received at each of the one or more low-frequency antennas and one or more high-frequency digital signals resulting from the high-frequency reflected energy received at each of the one or more high-frequency antennas and to control an operation of a vehicle based on information obtained by processing the low-frequency reflected energy and the high-frequency reflected energy.

In addition to one or more of the features described herein, the method also includes coupling one or more first channels with the one or more low-frequency antennas to output the one or more low-frequency digital signals and coupling one or more second channels with the one or more high-frequency antennas to output the one or more high-frequency digital signals.

In addition to one or more of the features described herein, the method also includes coupling one or more channels, in turn, with one of the one or more low-frequency antennas to output one of the one or more low-frequency digital signals and with one of the one or more high-frequency antennas to output one of the one or more high-frequency digital signals, and arranging one or more switches to couple one of the one or more low-frequency antennas or one of the one or more high-frequency antennas to one of the one or more channels in turn.

In addition to one or more of the features described herein, the method also includes configuring the processor to perform a fast Fourier transform (FFT) on the one or more low-frequency digital signals over a set of range values to obtain one or more low-frequency range FFT results and to perform an FFT on the one or more high-frequency digital signals to obtain one or more high-frequency range FFT results.

In addition to one or more of the features described herein, the method also includes configuring the processor to perform a second FFT on a combination of the one or more low-frequency range FFT results over a set of Doppler values to obtain a low-frequency Doppler FFT result.

In addition to one or more of the features described herein, based on the low-frequency Doppler FFT result, the method also includes configuring the processor includes configuring the processor to obtain a low-frequency beamforming result that indicates an energy level at each of the set of range values, each of the set of Doppler values, and each of a set of angles at which an object may be positioned and to detect one or more objects based on the indication of energy level, each of the one or more objects being associated with one of the set of range values, one of the set of Doppler values, and one of the set of angles.

In addition to one or more of the features described herein, the method also includes configuring the processor to identify one or more regions of interest (ROI) corresponding with each of the one or more objects, each ROI including the one of the set of range values, the one of the set of Doppler values, and the one of the set of angles associated with the object and the ROI corresponding with ROI range values, ROI Doppler values and ROI angles.

In addition to one or more of the features described herein, the method also includes configuring the processor to perform a second FFT or a discrete Fourier transform (DFT) on a combination of portions of the one or more high-frequency range FFT results that correspond with the ROI range values over a set of Doppler values that correspond with the ROI Doppler values to obtain a high-frequency Doppler Fourier transform result.

In addition to one or more of the features described herein, the method also includes, based on the high-frequency Doppler Fourier transform result, configuring the processor to obtain a high-frequency beamforming result that indicates an energy level at each of the ROI range values, each of the ROI Doppler values, and each of the ROI angles and to detect one or more objects based on the indication of energy level.

In addition to one or more of the features described herein, the method also includes configuring the processor to retain only ones of the one or more objects detected using the high-frequency beamforming result that correspond with one of the one or more objects detected using the low-frequency beamforming result.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that includes a hybrid low-frequency and high-frequency radar system according to one or more embodiments;

FIG. 2 is a block diagram of a hybrid low-frequency and high-frequency radar system according to an exemplary embodiment;

FIG. 3 is a block diagram of a hybrid low-frequency and high-frequency radar system according to an exemplary embodiment; and

FIG. 4 is a process flow of a method of processing digital signals obtained from reflected energy received by a hybrid low-frequency and high-frequency radar system according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, a radar system is among the sensors that may be used to obtain information about objects around a vehicle. The frequency of transmitted energy from the radar system affects the resolution with which the information is obtained. Specifically, increasing the transmitted frequency results in obtaining a higher angular resolution (i.e., DOA resolution) and Doppler resolution based on processing subsequent resulting reflections. However, as transmitted frequency increases, the range at which objects may be detected (i.e., detection range) decreases. In addition, an increased number of receive antennas is needed for the DOA resolution. Further, an increase in Doppler resolution comes with an increase in ambiguity. Ambiguity refers to, for example, an object with a range rate of 15 meters per second (m/s) also appearing at 30 m/s and additional multiples such that the true objects are not easily discernable from false ones.

Embodiments of the systems and methods detailed herein relate to a hybrid low-frequency and high-frequency radar system. The terms low-frequency and high-frequency are used to indicate relative frequencies rather than absolute ranges or values. That is, the frequency of any of the high-frequency transmitted signals (e.g., on the order of 240 gigahertz (GHz)) is at least one and a half times greater than the frequency of any of the low-frequency transmitted signals (e.g., on the order of 77-81 GHz). As detailed, processing reflections that are received as a result of the low-frequency transmitted signals, which are referred to as low-frequency reflections, facilitates addressing issues that result from processing reflections that result from the high-frequency transmitted signals, which are referred to as high-frequency reflections.

That is, the detections obtained using low-frequency signals are more robust to ambiguity in Doppler and in DOA than those obtained using the high-frequency signals. As a result, detections obtained using the low-frequency signals can be used to determine whether the Doppler frequency and DOA detections obtained by using the high-frequency signals are ambiguous or real. Specifically, a region of interest is identified based on low-frequency reflections, and only high-frequency reflections associated with that region of interest are processed. The processing of the high-frequency reflections results in higher resolution than the processing of the low-frequency reflections. In addition, ambiguity resulting from the high-frequency reflections is resolved by comparing the results of processing the low-frequency reflections and the high-frequency reflections. Specifically, Doppler detections based on processing the high-frequency reflections are only retained if they correspond with detections based on processing low-frequency reflections.

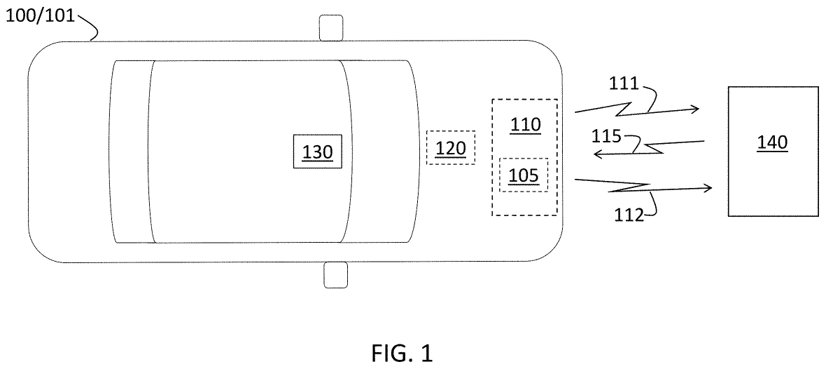

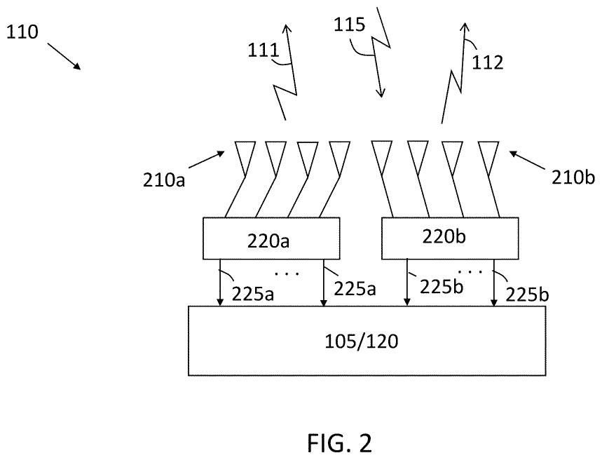

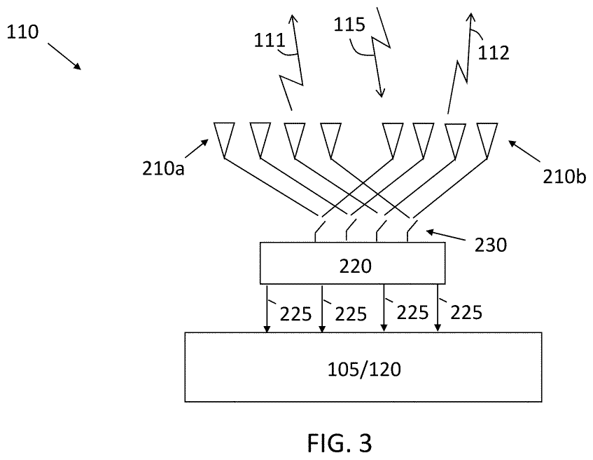

In accordance with an exemplary embodiment, FIG. 1 is a block diagram of a vehicle 100 that includes a hybrid low-frequency and high-frequency radar system 110. The exemplary vehicle 100 shown in FIG. 1 is an automobile 101. Aspects of the radar system 110 are further detailed in FIGS. 2 and 3. The vehicle 100 also includes a controller 120 and other sensors 130 (e.g., cameras, lidar system). The numbers and locations of the radar system 110 and other sensors 130 around the vehicle 100 are not limited by the exemplary illustration in FIG. 1. The controller 120 may obtain information from the radar system 110 and other sensors 130 to control an operation of the vehicle 100. Exemplary operations include collision avoidance, automatic braking, and adaptive cruise control.

The controller 120, a controller 105 within the radar system 110, or a combination of the two performs detection of one or more objects 140 (e.g., other vehicles, pedestrians). The detection is based on processing reflected energy 115 that results from the low-frequency transmissions 111 and high-frequency transmissions 112 of the radar system 110. The controller 120 and the controller 105 of the radar system 110 include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

FIG. 2 is a block diagram of a hybrid low-frequency and high-frequency radar system 110 according to an exemplary embodiment. Four low-frequency antennas 210a that emit low-frequency transmissions 111 and four high-frequency antennas 210b that emit high-frequency transmissions 112 are shown. Alternate embodiments of the radar system 110 may include any number of antennas 210. According to the embodiment shown in FIG. 2, the radar system 110 includes separate low-frequency receiver channels 220a and high-frequency receiver channels 220b (generally referred to as 220). Each antenna 210 is coupled to a different receiver channel 220 such that, in the exemplary case, four low-frequency receiver channels 220a respectively couple to the four low-frequency antennas 210a and four high-frequency receiver channels 220b respectively couple to the four high-frequency antennas 210b.

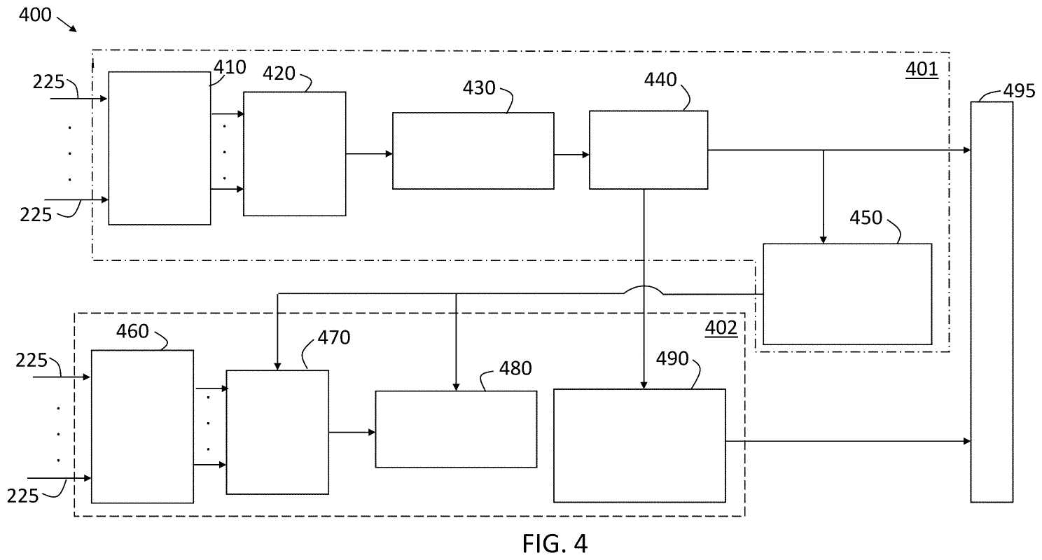

Each of the receiver channels 220 includes known components such as amplifiers, mixers, and analog-to-digital converters to down-convert the reflected energy 115 received at each antenna 210 and output a digital signal 225. The digital signals 225a, 225b (generally referred to as 225) that are output by the receiver channels 220 are processed by the controller 105 of the radar system 110, by the controller 120 of the vehicle 100, or a combination of both. This processing is further discussed with reference to FIG. 4.

FIG. 3 is a block diagram of a hybrid low-frequency and high-frequency radar system 110 according to an exemplary embodiment. Four low-frequency antennas 210a and four high-frequency antennas 210b are shown in the exemplary case, as they were in FIG. 2. A single set of receiver channels 220, a set of four in the exemplary case, is used for both the low-frequency antennas 210a and the high-frequency antennas 210b. The use of the common set of receiver channels 220 is facilitated by switches 230 that connect the low-frequency antennas 210a and the high-frequency antennas 210b to the receiver channels 220 in turn. A digital signal 225 is output from each of the receiver channels 220 based on the corresponding input from a low-frequency or high-frequency antenna 210. As previously noted, the processing of the digital signals 225 by the controller 105 of the radar system 110, by the controller 120 of the vehicle 100, or a combination of both is further discussed with reference to FIG. 4.

FIG. 4 is a process flow of a method 400 of processing digital signals 225 obtained from reflected energy 115 received by a hybrid low-frequency and high-frequency radar system 110 according to one or more embodiments. As FIG. 4 indicates, the processes are generally divided into low-frequency processes 401 and high-frequency processes 402. The digital signals 225 that are input to the low-frequency processes 401 result from processing reflected energy 115 that is received due to the low-frequency transmissions 111 (e.g., digital signals 225 produced by the receiver channels 220a). The digital signals 225 that are input to the high-frequency processes 402 result from processing reflected energy 115 that is received due to the high-frequency transmissions 112 (e.g., digital signals 225 produced by the receiver channels 220b). The low-frequency processes 401 (at blocks 410 through 450) and the high-frequency processes 412 (at blocks 460 through 490) are detailed.

At block 410, obtaining a range fast Fourier transform (FFT) refers to performing an FFT on each of the digital signals 225 (obtained using low-frequency transmissions 111) along a set of range values. The result is an indication of energy level over the set of range values (i.e., range bins). As FIG. 4 indicates, the number of outputs from the range FFT process at block 410 is the same as the number of digital signals 225 input to the range FFT process. At block 420, obtaining Doppler FFT refers to combining the various range FFT outputs from block 410 and performing another FFT process. The result indicates energy level over the range bins and also along Doppler bins. At block 430, a beamforming process is performed. This is a low-resolution process relative to the beamforming (at block 480) that is part of the high-frequency processes 402. The range FFT, Doppler FFT, and beamforming processes are generally well-known in radar detection and are discussed here for the purpose of highlighting how the processes are modified in the hybrid radar system 110.

At block 430, performing beamforming refers to determining the energy level over each of the range bins and each of the Doppler bins for each of a set of DOAs. Performing detection, at block 440, refers to identifying one or more objects 140 based on a range bin, Doppler bin, and DOA for which the corresponding energy level is highest (e.g., exceeds a threshold value). At block 450, determining a region of interest (ROI) refers to determining a subset of the range bins, Doppler bins, and DOA values within which detections are identified (at block 440). The ROI may not be limited to the exact range bin, Doppler bin, and DOA of a detected object 140. This is because a detected object 140 (e.g., another vehicle) may result in multiple detections based on multiple parts (e.g., front bumper, side mirror) of the same object 140 being sources of reflected energy 115. Thus, the ROI may include a range bin subset, a Doppler bin subset, and a DOA subset, where the subset is sized according to the largest object 140 that is expected to be detected. This is further discussed with reference to block 490.

At block 460, obtaining a range FFT refers to performing an FFT on each of the digital signals 225 (obtained using high-frequency transmissions 112) along the set of range values. The result is an indication of energy level over the set of range values (i.e., range bins), and, as discussed for the low-frequency processes 401, a separate range FFT result is obtained for each of the digital signals 225. At block 470, obtaining Doppler FFT or discrete Fourier transform (DFT) refers to combining the various range FFT outputs from block 460 and performing another FFT process or a DFT process. However, as FIG. 4 indicates, output of the ROI determination (at block 450) is input to block 470 along with the range FFT outputs. Thus, a Doppler FFT or DFT is not performed over the entirety of the range FFT results but, instead, is limited to the range bins and Doppler bins within the ROI (i.e., the range bins and Doppler bins within which an object 140 was detected at block 440).

At block 480, a beamforming process is performed. This is a high-resolution process relative to the beamforming (at block 430) that is part of the low-frequency processes 401. The computational cost of this higher resolution process is reduced by both the fact that the use of the ROI at block 470 results in a smaller Doppler FFT input to block 480 and the fact that the beamforming process only considers DOAs in the ROI. Thus, performing beamforming refers to determining the energy level at the range bins and the Doppler bins for the DOAs within the ROI (per block 450).

At block 490, detecting and eliminating ambiguous detections refers to performing detection, similarly to the process at block 440, and then comparing the results with those of the process at block 440. As noted with reference to block 450, different parts of the same object 140 (e.g., large truck perpendicular to the vehicle 100) may be detected. That is, reflected energy 115 may result from a front bumper based on the low-frequency transmissions 111 and reflected energy may also result from a rear bumper based on high-frequency transmissions 112. In this case, the DOA will not be the same for the detected object 140 (i.e., the large truck) at blocks 440 and 490 but will be within the ROI DOA subset. Further, the Doppler determined using the low-frequency transmissions 111 and the high-frequency transmissions 112 will be the same or at least within the ROI Doppler subset. Eliminating ambiguous detections, at block 490, refers to retaining only the detections that correspond with detections at block 440. At block 495, the detections from blocks 440 and 490 are further processed to facilitate the control of an action of the vehicle 100 by the controller 120 based on the one or more objects 140 indicated by the detections.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A hybrid radar system comprising:
one or more low-frequency antennas configured to receive low-frequency reflected energy resulting from reflection of low-frequency transmissions;
one or more high-frequency antennas configured to receive high-frequency reflected energy resulting from reflection of high-frequency transmissions, wherein a frequency of the high-frequency transmissions is at least 1.5 times a frequency of the low-frequency transmissions; and
a processor configured to obtain and process one or more low-frequency digital signals resulting from the low-frequency reflected energy received at each of the one or more low-frequency antennas and one or more high-frequency digital signals resulting from the high-frequency reflected energy received at each of the one or more high-frequency antennas and to control an operation of a vehicle based on information obtained by processing the low-frequency reflected energy and the high-frequency reflected energy.

2. The hybrid radar system according to claim 1, further comprising one or more first channels corresponding with the one or more low-frequency antennas to output the one or more low-frequency digital signals and one or more second channels corresponding with the one or more high-frequency antennas to output the one or more high-frequency digital signals.

3. The hybrid radar system according to claim 1, further comprising one or more channels, wherein each of the one or more channels corresponds, in turn, with one of the one or more low-frequency antennas to output one of the one or more low-frequency digital signals and with one of the one or more high-frequency antennas to output one of the one or more high-frequency digital signals, and one or more switches, wherein each of the one or more switches is configured to couple one of the one or more low-frequency antennas or one of the one or more high-frequency antennas to one of the one or more channels in turn.

4. The hybrid radar system according to claim 1, wherein the processor is configured to perform a fast Fourier transform (FFT) on the one or more low-frequency digital signals over a set of range values to obtain one or more low-frequency range FFT results and to perform an FFT on the one or more high-frequency digital signals to obtain one or more high-frequency range FFT results.

5. The hybrid radar system according to claim 4, wherein the processor is configured to perform a second FFT on a combination of the one or more low-frequency range FFT results over a set of Doppler values to obtain a low-frequency Doppler FFT result.

6. The hybrid radar system according to claim 5, wherein, based on the low-frequency Doppler FFT result, the processor is configured to obtain a low-frequency beamforming result that indicates an energy level at each of the set of range values, each of the set of Doppler values, and each of a set of angles at which an object may be positioned and to detect one or more objects based on the indication of energy level, each of the one or more objects being associated with one of the set of range values, one of the set of Doppler values, and one of the set of angles.

7. The hybrid radar system according to claim 6, wherein the processor is configured to identify one or more regions of interest (ROI) corresponding with each of the one or more objects, each ROI including the one of the set of range values, the one of the set of Doppler values, and the one of the set of angles associated with the object and the ROI corresponding with ROI range values, ROI Doppler values and ROI angles.

8. The hybrid radar system according to claim 7, wherein the processor is configured to perform a second FFT or a discrete Fourier transform (DFT) on a combination of portions of the one or more high-frequency range FFT results that correspond with the ROI range values over a set of Doppler values that correspond with the ROI Doppler values to obtain a high-frequency Doppler Fourier transform result.

9. The hybrid radar system according to claim 8, wherein, based on the high-frequency Doppler Fourier transform result, the processor is configured to obtain a high-frequency beamforming result that indicates an energy level at each of the ROI range values, each of the ROI Doppler values, and each of the ROI angles and to detect one or more objects based on the indication of energy level.

10. The hybrid radar system according to claim 9, wherein the processor is configured to retain only ones of the one or more objects detected using the high-frequency beamforming result that correspond with one of the one or more objects detected using the low-frequency beamforming result.

11. A method of assembling a hybrid radar system, the method comprising:
arranging one or more low-frequency antennas to receive low-frequency reflected energy resulting from reflection of low-frequency transmissions;
arranging one or more high-frequency antennas to receive high-frequency reflected energy resulting from reflection of high-frequency transmission, wherein a frequency of the high-frequency transmissions is at least 1.5 times a frequency of the low-frequency transmissions; and
configuring a processor to obtain and process one or more low-frequency digital signals resulting from the low-frequency reflected energy received at each of the one or more low-frequency antennas and one or more high-frequency digital signals resulting from the high-frequency reflected energy received at each of the one or more high-frequency antennas and to control an operation of a vehicle based on information obtained by processing the low-frequency reflected energy and the high-frequency reflected energy.

12. The method according to claim 11, further comprising coupling one or more first channels with the one or more low-frequency antennas to output the one or more low-frequency digital signals and coupling one or more second channels with the one or more high-frequency antennas to output the one or more high-frequency digital signals.

13. The method according to claim 11, further comprising coupling one or more channels, in turn, with one of the one or more low-frequency antennas to output one of the one or more low-frequency digital signals and with one of the one or more high-frequency antennas to output one of the one or more high-frequency digital signals, and arranging one or more switches to couple one of the one or more low-frequency antennas or one of the one or more high-frequency antennas to one of the one or more channels in turn.

14. The method according to claim 11, further comprising configuring the processor to perform a fast Fourier transform (FFT) on the one or more low-frequency digital signals over a set of range values to obtain one or more low-frequency range FFT results and to perform an FFT on the one or more high-frequency digital signals to obtain one or more high-frequency range FFT results.

15. The method according to claim 14, further comprising configuring the processor to perform a second FFT on a combination of the one or more low-frequency range FFT results over a set of Doppler values to obtain a low-frequency Doppler FFT result.

16. The method according to claim 15, further comprising, based on the low-frequency Doppler FFT result, configuring the processor to obtain a low-frequency beamforming result that indicates an energy level at each of the set of range values, each of the set of Doppler values, and each of a set of angles at which an object may be positioned and to detect one or more objects based on the indication of energy level, each of the one or more objects being associated with one of the set of range values, one of the set of Doppler values, and one of the set of angles.

17. The method according to claim 16, further comprising configuring the processor to identify one or more regions of interest (ROI) corresponding with each of the one or more objects, each ROI including the one of the set of range values, the one of the set of Doppler values, and the one of the set of angles associated with the object and the ROI corresponding with ROI range values, ROI Doppler values and ROI angles.

18. The method according to claim 17, further comprising configuring the processor to perform a second FFT or a discrete Fourier transform (DFT) on a combination of portions of the one or more high-frequency range FFT results that correspond with the ROI range values over a set of Doppler values that correspond with the ROI Doppler values to obtain a high-frequency Doppler Fourier transform result.

19. The method according to claim 18, further comprising, based on the high-frequency Doppler Fourier transform result, configuring the processor to obtain a high-frequency beamforming result that indicates an energy level at each of the ROI range values, each of the ROI Doppler values, and each of the ROI angles and to detect one or more objects based on the indication of energy level.

20. The method according to claim 19, further comprising configuring the processor to retain only ones of the one or more objects detected using the high-frequency beamforming result that correspond with one of the one or more objects detected using the low-frequency beamforming result.
